(19) United States
(12) Patent Application Publication
(10) Pub. No.: US 2003/0124294 A1
(43) Pub. Date: Jul. 3, 2003

(54) Scored package and a method of making the same

(76) Inventors: Jay D. Hodson, Greenville, WI (US); Chad M. Perre, Oshkosh, WI (US); Duane H. Buelow, Neenah, WI (US)

Correspondence Address: Stephen T. Scherrer, McDermott, Will & Emery, 227 West Monroe Street, Chicago, IL, 60606-5096, US

(21) Appl. No.: 10/034,886

(22) Filed: Dec. 28, 2001

(51) Int. Cl. B65B 61/18; G09F 3/00

(52) U.S. Cl. 428/43; 53/412

(57) ABSTRACT

The present invention relates to a flexible pouch that is sealed on the sides to provide a space therein for a product. On one end of the pouch may be a recloseable feature. A patterned score line may be provided on an end of the pouch for removing a sheath disposed over the recloseable feature thereby exposing the recloseable feature. The pouch may be utilized for the storage of food products, such as cheese.

### FIELD OF THE INVENTION

The present invention relates to a film that is irradiated by a focused laser beam to provide a patterned score line on the film. In addition, the present invention relates to a package that may be torn along the score line. More specifically, the package may have a recloseable feature to open and then reclose the package, such as, for example, a zipper. The score line may allow the package to be opened using pull-apart forces, thereby exposing the recloseable feature allowing a user of the package to gain access to the interior of the package for items that may be contained therein.

### BACKGROUND OF THE INVENTION

It is generally known for packaging, such as flexible plastic packaging, to hold and/or store products, such as food products. More specifically, it is known for flexible plastic packaging to contain a plurality of layers wherein each of the layers has one or more features that may be important to holding and storing food products contained within the packaging.

Recloseable features are utilized on flexible plastic packaging to allow an individual to gain access to a product contained therein, and to then seal the product within the packaging for later use. For example, a recloseable plastic zipper can be incorporated into the plastic packaging. The plastic zipper typically is attached on an end of the packaging and utilized to provide an opening in the end of the package. Alternatively, the plastic zipper is attached to inside surfaces of the package and is exposed when a portion of the plastic packaging is removed from the plastic packaging.

The flexible plastic packaging typically is provided with a feature that allows the portion of the plastic packaging to be removed from the plastic packaging thereby exposing the recloseable feature. This feature is a tear tape or a score line that is incorporated into the packaging. For example, a heat sealable tear tape is heat sealed to an inside surface of a plastic packaging that is folded and sealed on its sides. The tear tape provides a hermetic seal on the top of the package and further allows the top portion of the plastic packaging to be removed from the remainder of the package when an end of the tear tape is gripped and pulled so that the tear tape tears across the package.

Of course, a score line is also used to allow the portion of the plastic packaging to be removed, thereby exposing the recloseable feature. Score lines can be etched into the plastic packaging by a plurality of methods, such as by machine scoring and/or laser scoring of the plastic film. For example, plastic packaging is mechanically scored by using a blade that may provide a slight etching in the plastic film to provide a line of weakness in the film so that the portion of the film may be torn from the remainder of the packaging using digital pull-apart forces.

A laser beam typically is used to vaporize or otherwise remove a portion of the plastic film to create lines of weakness in the plastic film. A plastic film is created via coextrusion and/or extrusion or adhesive lamination and proceeds as a flat moving web that is etched by a non-moving laser source to provide a single line of weakness in the machine direction of the web. Of course, a plurality of laser sources can be provided to create a plurality of score lines in the machine direction of the web.

It is further known that a laser beam may create lines of weakness in two independent directions, as well. For example, U.S. Pat. No. 5,001,325 to Huizinga illustrates a multilayer film that may be scored via a laser beam in two directions, i.e. the machine direction and transverse to the machine direction, or, generically, the X and Y directions on the surface of the film. Scanners typically scan for recurring patterns on the film and signal for the movement of the laser beam over the advancing film in the two perpendicular directions.

Packages are known that contain a product, such as, for example, a cheese product. A typical package consists of two flat multilayer films that are heat sealed on three sides to provide a compartment therein. For example, a single multilayer film is folded and sealed on its sides to provide the package. On the fourth side, a resealable feature is provided for opening and closing the package to add and/or remove the product from the package. The recloseable feature is a zipper that opens or closes the package when the slider is moved laterally over the open end of the package. However, the open end of the package containing the recloseable feature must be initially hermetically sealed to keep and store the product that is contained therein. A typical hermetic seal is provided below the zipper, which is opened by pull-apart forces when the package is opened for the first time.

Alternatively, the zipper is provided on inside surfaces of the package. The outer surfaces of the package therefore extend over the zipper and are hermetically sealed at a position over the zipper thereby providing a sheath over the zipper. Not only does this configuration provide a hermetic seal for the package, but the sheath further protects the zipper. To remove the sheath, score lines or tear tapes are provided so that the sheath is torn and the zipper exposed. However, the sheath is typically removed below the zipper so as to expose the zipper when the sheath is torn away.

FIG. 1 illustrates a prior art package 500 with a sheath 501 extending over a zipper 504 and having a one-dimensional score line 502 that extends horizontally across the sheath 501 at a position below the zipper 504. When the sheath 501 is torn at the score line 502, made easier by the use of a notch 506 in the side of the package 500, the zipper 504 is exposed, and the package 500 may be opened or closed by the zipper 504. However, to tear the sheath 501 below the zipper 504 and remove the sheath 501, thereby exposing the zipper 504, the tracks of the zipper 504 cannot extend to the edges of the package 500, or the tracks of the zipper 504 would remain attached to the edges of the sheath 501 and the sheath 501 would not be removable below the zipper 504. The opening provided by the zipper 504 is, by necessity, smaller than the width of the package 500. The opening, therefore, restricts the movement of articles into and out of the package 500. Moreover, the package, having a smaller opening than the width of the package, is aesthetically displeasing because it appears that the zipper is sized incorrectly and does not fit the package.

One way to solve this problem and allow a zipper to extend from one edge of the package to a second edge of the package is illustrated in FIG. 2, which illustrates a prior art package 600 with a sheath 601 extending over a zipper 604 and having a one dimensional score line 602 that extends horizontally across the sheath 601 at a position below the zipper 604. However, the score line 602 is disposed between holes 608 that are stamped in the sheath 601. Notches 606 are provided above the zipper 604 to allow the sheath 601 to be torn above the zipper 604 and allow the path of the tear to travel below the zipper 604 and, therefore, across the sheath 601 via the score line 602. A drawback of this package, however, is that the sheath 601 would not provide a hermetic seal when sealed over the zipper because of the holes 608 that are stamped into the sheath 601. Therefore, a hermetic seal 610 is provided on the inside of the package 600 below the zipper. When the seal 610 is broken by pull-apart forces, the contents of the package are exposed. This packaging system must, however, include the extra steps of stamping the holes in the sheath, and providing the hermetic heat seal on the inside surfaces of the package. In addition, the film necessarily needs a heat sealable film at the specific location below the zipper so that the walls of the package can be heatsealed together.

A need exists, therefore, for a package that includes a recloseable feature, such as a zipper, that is protected by a hermetically sealed sheath. Moreover, the recloseable feature should be provided across an entire width of the package, and the sheath should be removable from the package, thereby exposing the recloseable feature. A need further exists for a package that does not need a hermetic seal across a width of the package below the recloseable feature.

### SUMMARY OF THE INVENTION

The present invention relates to a package that is sealed on three sides and recloseable on a fourth side. The recloseable feature may be a recloseable zipper that may extend over an entire width of the package. The outside surface of the package extends over the recloseable feature and is hermetically sealed above the recloseable feature thereby providing a sheath over the recloseable feature. The sheath is torn from a remainder of the package using digital pull-apart forces. When torn by digital pull-apart forces, the sheath may initially tear above the recloseable feature and the tear may proceed below the recloseable feature across almost the entire width of the package following a two-dimensional score line in the outside surfaces of the package. This score line may, therefore, allow the sealed edges of the recloseable feature to remain clear of the removable portion of the sheath.

To this end, in an embodiment of the present invention, a package is provided comprising a first side wall; a second side wall wherein the first side wall and the second side wall are bonded together on edges to form a pouch having a space therein for storing a product; a recloseable feature disposed on inside surfaces of the side walls wherein the side walls are sealed together on an end of the package; and a score line in at least one side wall from a first edge to a second edge of the at least one side wall wherein the score line traces a path from above the recloseable feature at said first edge to below the recloseable feature between the edges when the pouch is oriented such that the recloseable feature is on a top side of the pouch.

In an alternate embodiment of the present invention, a package for a product is provided comprising a first side wall; a second side wall wherein the first side wall and the second side wall are bonded together on edges to form a pouch having a space therein for storing a product; a recloseable feature on an end of the package; a sheath disposed over the recloseable feature wherein the sheath has a first end, a second end, and side edges, and further wherein a first end of the sheath is integrally attached to the side walls of the package; and a score line in the sheath from a first edge to a second edge of the sheath wherein the score line traces a path from above the recloseable feature at the edges to below the recloseable feature between the edges when the pouch is oriented such that the recloseable feature is on a top side of the pouch.

In a further embodiment of the present invention, a package for products is provided comprising a pouch comprising side walls having a seal on all sides to form a space for retaining a product; a recloseable feature disposed near one of the sealed sides of the pouch wherein the recloseable feature is sealed to inside surfaces of the pouch and further wherein the side walls extend over the recloseable feature; and a score line in at least one side wall from a first edge to a second edge of the at least one side wall wherein the score line traces a path from above the recloseable feature at the side edges to below the recloseable feature between the side edges when the pouch is oriented such that the recloseable feature is on a top side of the pouch.

In an alternate embodiment of the present invention, a method of making a package is provided comprising the steps of providing a first wall and a second wall; scoring a score line in at least one side wall; providing a recloseable feature attached at a first end of the side walls; attaching the recloseable feature to inside surfaces of the side walls; and sealing the first wall and the second wall together on edges of the walls to form a pouch having a space therein for a product, wherein said score line is disposed above the recloseable feature at edges of the side walls and further wherein said score line traces a path to below the recloseable feature between the edges of the side walls.

Still further, in an alternate embodiment of the present invention, a method of making a package is provided comprising the steps of providing a sheet of a flexible film material; providing a score line in the sheet of flexible film material; sealing a first side of a recloseable feature to the flexible film material; folding the sheet and sealing the sheet on side edges of the sheet to form a pouch having a space therein for a product wherein the pouch has an open end; sealing a second side of the recloseable feature to the flexible film material; filling the pouch with product; and sealing the open end of the pouch, wherein the score line is disposed in the sheet of flexible film material from a first to a second edge of the pouch wherein the score line traces a path from above the recloseable feature at the edges of the pouch to below the recloseable feature between the edges of the pouch when the pouch is oriented such that the recloseable feature is on a top side of the pouch.

And finally, in a still further alternate embodiment of the present invention, a method of using a package is provided comprising the steps of providing a package comprising a pouch having a product contained therein wherein said pouch has a recloseable feature on an end of the pouch and further wherein side walls of said pouch extend over the recloseable feature and further wherein said pouch has a score line disposed in the package from a first edge of the package to a second edge of the package wherein the score line traces a path from above the recloseable feature at the side edges of the package to below the recloseable feature between the side edges of the package; and tearing said package along said score line to gain access to said pouch.

It is, therefore, an advantage of the present invention to provide a package that may keep and store a product, such as a product that may have a limited shelf-life. For example, the product may be a food product, such as cheese. The package may be hermetically sealed on all sides and may further restrict the movement of moisture and/or oxygen through the walls of the package, thereby keeping the product contained therein fresh.

In addition, it is an advantage of the present invention to provide a package having a recloseable feature on an end of the package so that food products may be stored and kept within the package after the hermetic seal on the package has been broken when the package is initially used by an individual attempting to retrieve the product contained therein. It is further advantageous that a sheath is provided that extends over the recloseable feature that may provide the hermetic seal on the package and further protect the recloseable feature.

Still further, it is an advantage of the present invention to provide a two-dimensional score line on the package that may allow the sheath to be removed, thereby exposing the recloseable feature. The score line may allow the sealed ends of the recloseable feature to remain clear of the removable portion of the sheath.

Additional features and advantages of the present invention are described in, and will be apparent from, the detailed description of the presently preferred embodiments and from the drawings.

### BRIEF DESCRIPTION OF THE FIGURES

FIG. 1 illustrates a plan view of a prior art package having a zipper that does not extend to the edges of the package and a one-dimensional score line provided across the package.

FIG. 2 illustrates a plan view of a prior art package having a zipper extending to the edges of the package and a one dimensional score line provided across the package with holes stamped in the package to direct the tearing of the package.

FIG. 3 illustrates a plan view of a flexible pouch having a zipper and further having a patterned score line provided on the flexible pouch in an embodiment of the present invention.

FIG. 4 illustrates a cross-sectional view along lines IV-IV of the flexible pouch showing the score lines and the zipper in an open configuration in an embodiment of the present invention.

FIG. 5 illustrates a cross-sectional view along line V-V of the flexible pouch showing the score lines and the zipper in a closed configuration in an embodiment of the present invention.

FIG. 6 illustrates a plan view of a flexible pouch having a zipper and further having a patterned score line in an alternate embodiment of the present invention.

FIG. 7 illustrates a cross-sectional view along line VII-VII of the flexible pouch in the alternate embodiment of the present invention.

FIG. 8 illustrates a plan view of a flexible pouch having a zipper and further having a patterned score line in an alternate embodiment of the present invention.

FIG. 9 illustrates a cross-sectional view along line IX-IX of the flexible pouch in the alternate embodiment of the present invention.

FIG. 10 illustrates a plan view of a flexible pouch having two-dimensional score lines therein being torn by digital pull-apart forces in an embodiment of the present invention.

FIG. 11 illustrates a plan view of a flexible pouch without the sheath and with the zipper exposed in an embodiment of the present invention.

FIG. 12 illustrates a cross-section of a package along line XII-XII in an embodiment of the present invention.

FIG. 13 illustrates a plan view of a flexible pouch having a zipper and further having a two-dimensional score line provided on the flexible pouch in an alternate embodiment of the present invention.

FIG. 14 illustrates a cross-sectional view along line XIV-XIV in an alternate embodiment of the present invention.

FIG. 15 illustrates a cross-sectional view along line XV-XV in an alternate embodiment of the present invention.

FIG. 16 illustrates a plan view of a flexible pouch without the sheath in an alternate embodiment of the present invention.

FIG. 17 illustrates a cross-sectional view along line XVII-XVII in an alternate embodiment of the present invention.

FIGS. 18A-18H illustrates a preferred method of making a flexible pouch having a zipper and a patterned score line in an embodiment of the present invention.

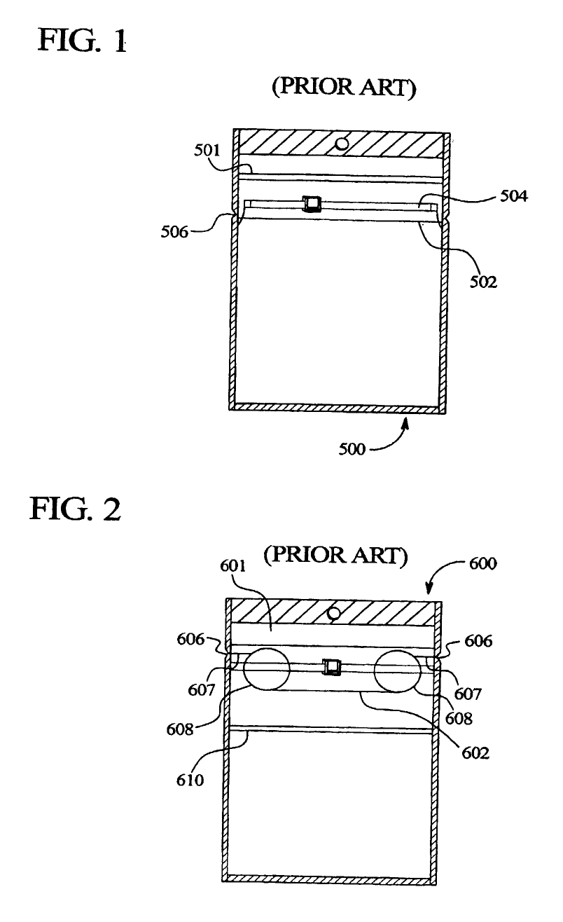

### DETAILED DESCRIPTION OF THE PRESENTLY PREFERRED EMBODIMENTS

The present invention relates to a flexible pouch that is sealed on the sides to provide a space therein for a product. On one end of the pouch may be a recloseable feature. A patterned score line may be provided on an end of the pouch for removing a sheath disposed over the recloseable feature thereby exposing the recloseable feature. The pouch may be utilized for the storage of food products, such as cheese or any other product that may be apparent to one having ordinary skill in the art.

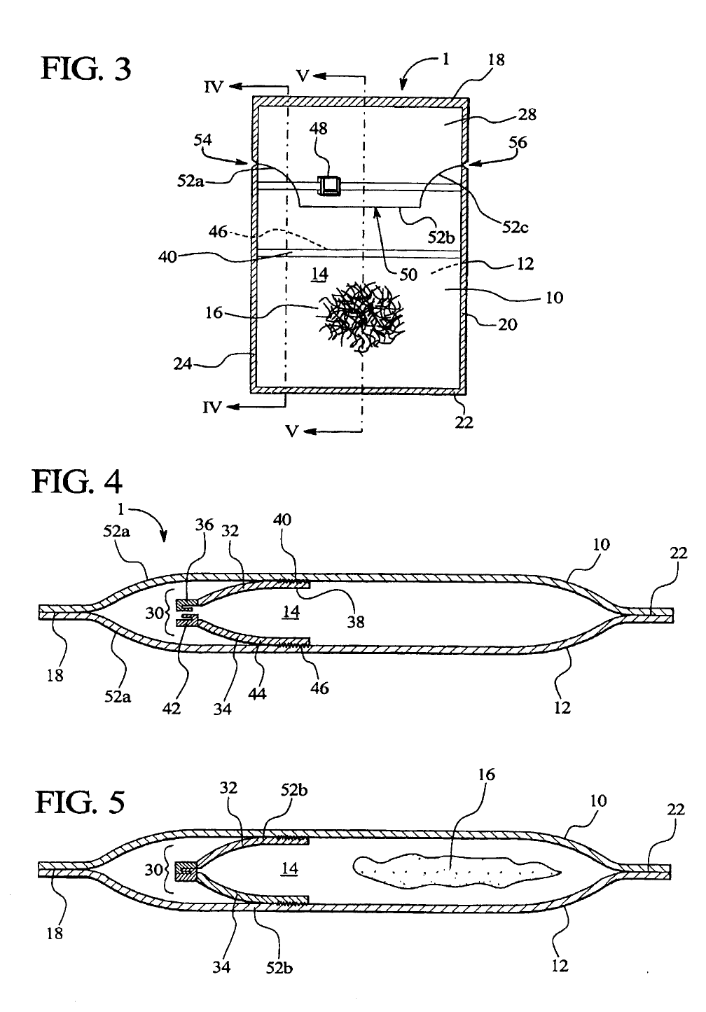

Now referring to the figures, wherein like numerals refer to like parts, FIG. 3 illustrates a food pouch 1 in an embodiment of the present invention. The food pouch 1 may have two side walls 10, 12 (as shown in FIGS. 4 and 5) made from multilayer flexible film that are heat sealed together to form a space 14 wherein a food product 16, or any other product 16, may be stored. The food product may preferably be a dairy product, such as a cheese product, that may be stored within the pouch 1.

The edges of the side walls 10,12 are heat sealed together to form seals 18, 20, 22 and 24. The seals may be hermetically sealed to provide a barrier for the movement of oxygen or moisture through the edges of the pouch 1. On one end 28 of the pouch 1 may be provided a recloseable feature that may preferably comprise a zipper system 30. Of course, however, other recloseable features may be utilized in this invention without detracting from the present invention. The zipper system 30 may comprise a first zipper portion 32 that is bonded to an inside surface of the side wall 10. In addition, the zipper system 30 may comprise a second zipper portion 34 that is bonded to an inside surface of the side wall 12.

The first zipper portion 32 may comprise a zipper track portion 36 that is attached to a film extender 38. The film extender 38 may be attached to the inside surface of the side wall 10 at seal 40. Similarly, the second zipper portion 34 may comprise a zipper track portion 42 that is attached to a film extender 44. The film extender 44 may be attached to the inside surface of the side wall 12 at seal 46. The seals 40,46 may extend over an entire width of the pouch 1, including within the seals 20,24. The zipper track portions 36,42 may be connectable together when a slider 48 is moved along tracks that may be provided on the zipper track portions 36,42. The slider 48 may close the zipper track portions 36,42 together to form a tight seal between the seals 20,24, as shown in FIG. 5.

FIG. 4 illustrates a cross-section of the pouch 1 along line IV-IV showing the side walls 10,12 sealed together at seals 18,22 and providing a space 14 therein for a food product 16. The zipper portions 32,34 of the zipper system 30 are shown heat sealed to the inside surfaces of the side walls 10,12, respectively. The zipper track portions 36,42 are shown open.

FIG. 5 illustrates a cross-section of the pouch 1 along line V-V showing the side walls 10,12 heat sealed together at seals 18,22 and providing a space 14 therein for a food product 16. The zipper portions 32,34 of the zipper system 30 are shown sealed to the inside surfaces of the side walls 10,12, respectively. The zipper track portions 36,42 are shown closed.

Still referring to FIG. 3, a score line 50 is provided in at least one of the side walls 10,12. In a preferred embodiment, the score line 50 may be provided in both of the side walls 10,12. The score line 50 may have a first curved portion 52a that may start on an edge of the pouch 1 and be disposed above the zipper track portions 36,42, when the pouch is oriented so that the zipper system 30 is at the top of the pouch 1. The curved portion 52a may trace a path that travels below the zipper track portions 36,42 until the curved portion 52a meets a generally straight portion 52b that traces a path across the face of the pouch 1 until the score line 50 reaches the proximity of the other end of the pouch 1. The score line 50 then meets a second curved portion 52c that traces a path from below the zipper track portions 36,42 to above the zipper track portions 36,42 to the edge of the pouch 1. Of course, the score line 50 may be any shape that may be apparent to one having ordinary skill in the art including tracing a path that goes below and above the zipper track portions 36.42 a plurality of times between the ends of the pouch 1. To facilitate the tearing of the score line 50 when digital pull-apart forces are applied, notches 54,56 may be provided on edges of the pouch to allow a tear to form in the side walls when pulled by digital pull apart forces.

The score line 50 is provided in the side wall 10 and/or 12 so as to allow an individual to grip the end 28 of the pouch 1 and tear the end 28 from the pouch 1 along the path of the score line 50. Because the zipper track portions 36,42 extend from one edge of the pouch 1 to the other edge of the pouch 1, the portion of the pouch 1 that is removed must clear the portions of the zipper track portions 36,42 that are heat sealed within the heat seals 20,24. However, the portion of the pouch 28 that is removed extends below the zipper track portions 36,42 so as to allow an individual to have easy access to the slider 48 to move the slider 48 back and forth along the zipper track portions 36,42.

The score line 50 may be scored via, preferably, a laser beam, or any other means apparent to one having ordinary skill in the art. The score line has a tensile value measured across the line of weakness of between about 3 and about 10 lbs/in. Preferably, the score line 50 has a tensile value measured across the line of weakness of about 6.5 lbs/in.

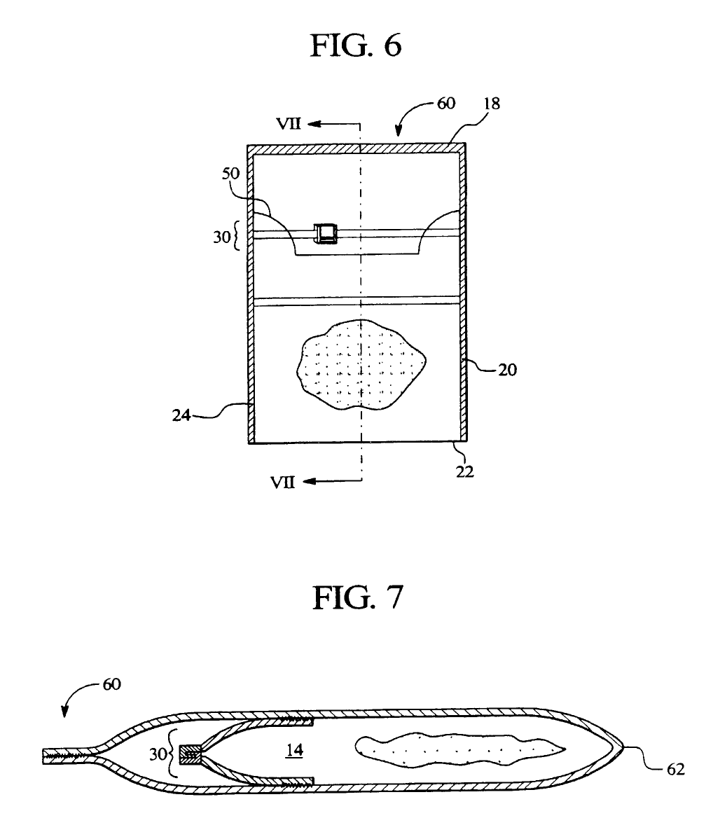

FIG. 6 illustrates an alternate embodiment of the present invention of a package 60 having the zipper system 30 and the score line 50, as described above with references to FIGS. 3-5. In addition, the package 60 includes the seals 18, 20 and 24. However, the package 60 does not include the seal 22, as shown in FIGS. 3-5. Instead, the walls of the package 60 may be constructed from a single sheet of flexible film and folded at fold 62, thereby providing a closed end on the package 60 without sealing the inside surfaces of the film together. FIG. 7 illustrates a cross section of the package 60 through line VII-VII showing the fold 62 on the end of the package 60. Of course, the package 60 may be sealed at the folded end of the package 60 to provide stiffer characteristics, such as if a hole is punched into the folded end of the package 60 to allow the package to hang on a hook for display purposes in a supermarket, for example.

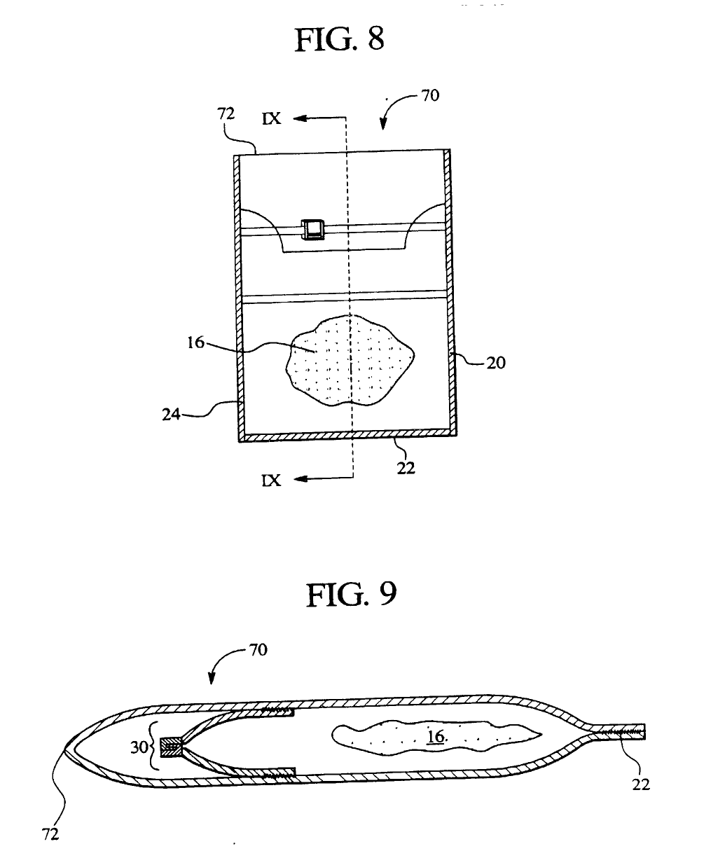

In a preferred embodiment of the present invention, a package 70 is shown in FIG. 8. The package 70 may be constructed like the package 60 shown in FIGS. 7-9 by a single sheet of flexible film that is folded at fold 72 and sealed to form seals 20, 22 and 24 on the other three sides of the package 70. The zipper system 30, however, may be provided near the end of the package 70 having the fold 72. Of course, the folded end of the package 70 may further have a seal to provide stiffer characteristics at the folded end of the package 70, such as if a hole is punched in the end of the package for hanging the package 70 for display purposes.

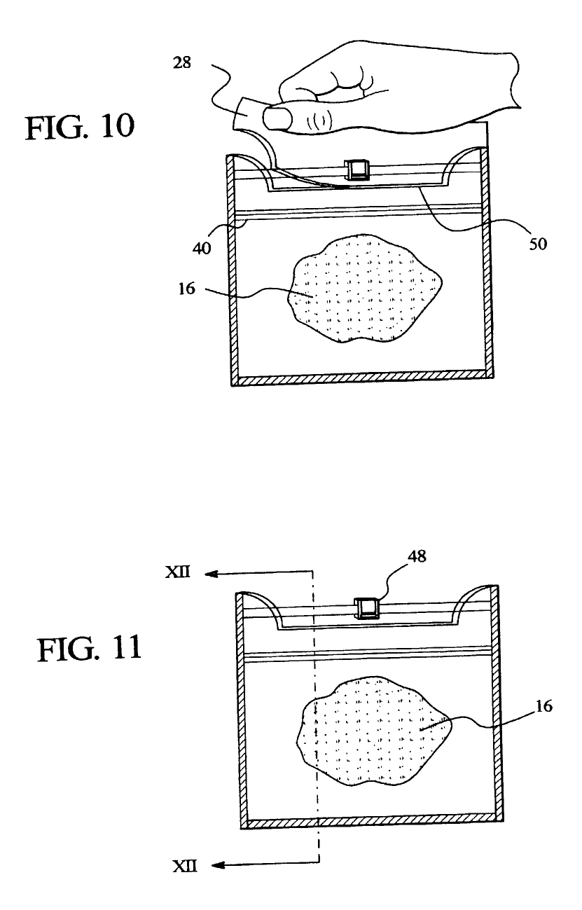

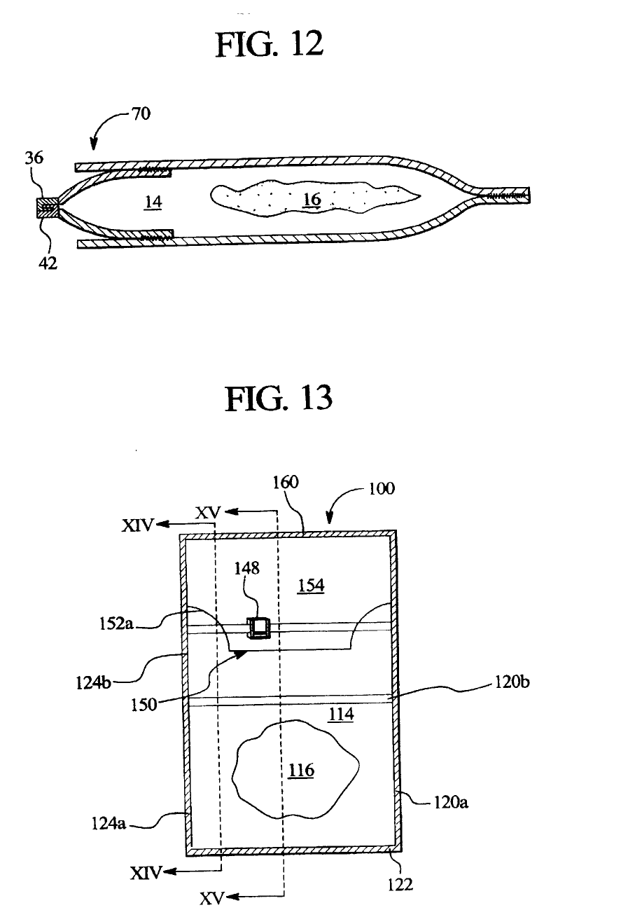

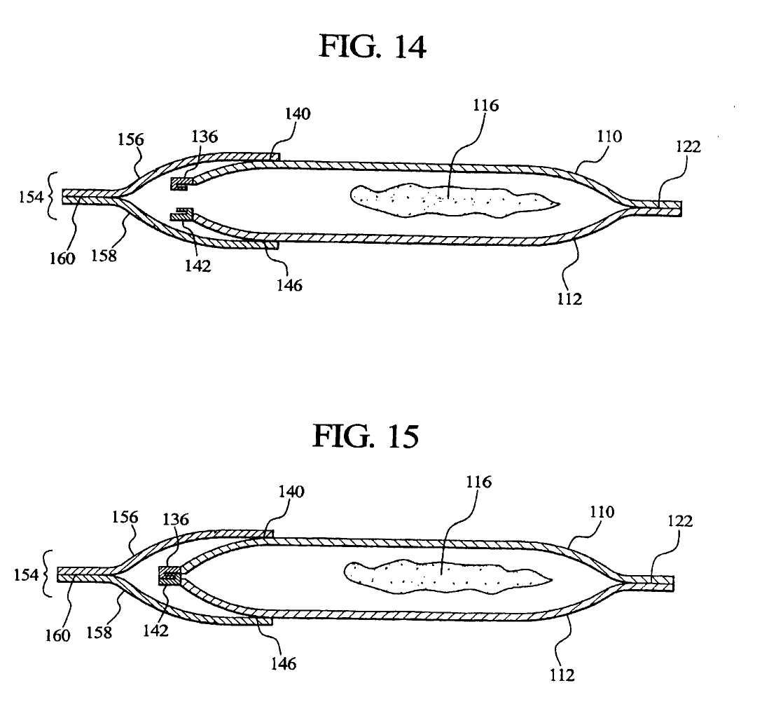

FIG. 10 illustrates the digital removal of the end 28 from the pouch 1 along the score line 50. As shown in FIG. 12, the removal of the end 28 exposes the zipper track portions 36,42 and the zipper slide 48 so that the zipper slide 48 may be slid along the zipper track portions 36,42 thereby opening or closing the pouch 1 to gain access to the product 16 contained therein.

FIG. 13 illustrates an alternate embodiment of a pouch 100 of the present invention. The pouch 100, similar to the pouch 1 as illustrated in FIG. 3, may be formed from two side walls 110,112 that may be heat sealed together along the edges of the side walls to form heat seals 120a, 122 and 124a. As stated above with reference to FIGS. 6-9, the pouch 100 may also be comprised of a single sheet of flexible film that is folded in half and sealed along the edges of the flexible film to form the pouch 100 having a space 114 therein for a product 116 to be contained therein.

On ends of the side walls 110,112 may be zipper track portions 136,142 that may be sealed or unsealed together via a zipper slide 148. The zipper track portions 136,142 may extend from one end of the pouch 100 to the other end of the pouch 100.

A sheath 150 is disposed over the zipper track portions 136,142 and may be heat sealed to outer surfaces of the side walls 110,112 via heat seals 140,146. The sheath 150 may be comprised of two flexible film sheets 152,154 wherein each of the flexible film sheet 152 and 154 are heat sealed to the outer surfaces of the side walls 110,112, respectively. The sheath 154 may have heat seals 120b,124b on two of the edges of the sheath 150. In addition, the sheath 150 may have an end seal 160. Alternatively, the sheath 154 may be a single sheet of flexible film that is folded at heat seal 160 and heat sealed to the outer surface of the side walls 110,112.

As in pouch 1, a score line 150 is cut into one or both sides of the sheath 150. The score line 150 may comprise a first curved portion 152a, a straight portion 152b that may trace a path from almost one end of the pouch to the other and may be disposed below the zipper track portions 136,142 when the zipper track portions 136,142 are oriented at the top of the pouch 100. The score line 150 may have a second curved portion 152c at a second edge of the pouch 100. Of course, any other shaped score line may be provided according to someone having ordinary skill in the art. When the sheath 150 is gripped and pulled using digital pull-apart forces, the sheath 154 tears along the score line 150 and provides access to the zipper track portions 136,142 and the zipper slide 148. However, the curved portions allow the sheath to clear the edges of the zipper track portions 136,142 that may be sealed in the heat seals 120b, 124b.

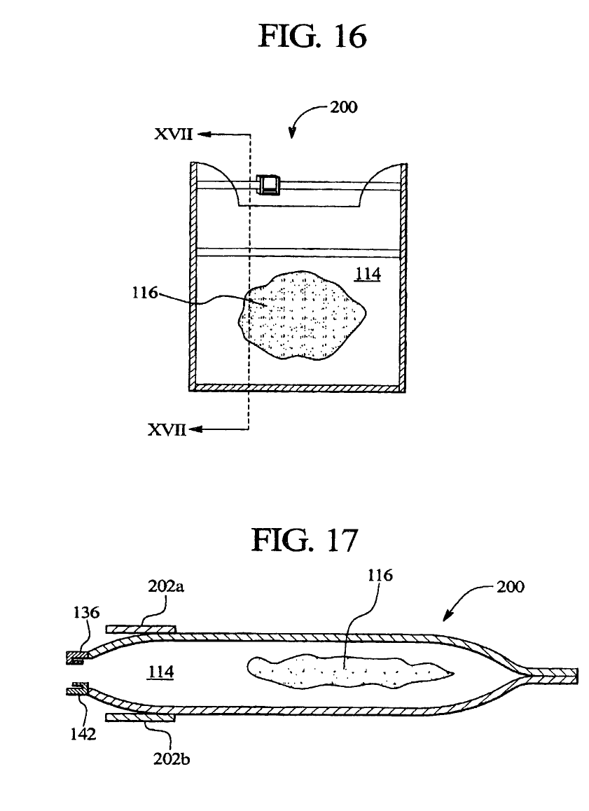

Still referring to FIG. 13, when the sheath 154 is gripped and pulled using digital pull-apart forces, the score line 150 may tear along first curved portion 152a, the straight portion 152b, and the second curved portion 152c to form a package 200, as shown in FIGS. 16 and 17. The package 200 may have a portion of the sheath 154 torn away and may leave sheath portions 202a,202b. The zipper track portions 136,142 may be revealed allowing an individual to gain access to the interior space 114 of the package 200. The zipper track portions 136,142 may be closeable and openable via a slider 148. Alternatively, the zipper track portions 136,142 may be closeable and openable in any way as may be apparent to one having ordinary skill in the art.

The packages of the present invention may be made from any flexible film material as may be apparent to one having ordinary skill in the art. The outer walls 10,12, as shown in FIG. 3 and outer walls 110,112, as shown in FIG. 13, may be multilayer films having individual layers used for their particular properties. For example, the outer layer of the pouch 1 or pouch 100 may be any conventional oriented film to provide abuse-resistance to the package and that may be easily scored via a laser, such as, for example, oriented polyester (PET) biaxially oriented nylon (BON), or oriented polypropylene (OPP). The inner layers of the multilayer film may be polyolefin based and/or foil such that a laser that may be utilized to cut a score line in the film may be most effective on the outer layer, yet allow the inner layer to remain relatively untouched. In addition, there may be barrier layers contained within the multilayer structures that may provide a barrier against oxygen and moisture from entering the space 14 of 114 of the pouch 1 or 100. The barrier material may be ethylene vinyl alcohol copolymer, polyvinylidene chloride-methyl acrylate copolymer, metal foil, metallized film, or any other barrier material apparent to one having ordinary skill in the art.

The inner layers of the flexible films (i.e. the layers that are heat sealed and/or come into contact with the product contained therein, may be any polymeric film material that may be apparent to one having ordinary skill in the art for the sealing of the flexible film to itself or to another film. Typical materials that may be utilized for the heat sealing layer may be low density polyethylene (LDPE), linear low density polyethylene (LLDPE), very low density polyethylene (VLDPE), ethylene vinyl acetate copolymer (EVA), ethylene methyl acrylate copolymer (EMA), single site or metallocene catalyzed polyethylene, or ionomer. In addition, the sheath 154, as shown in FIG. 13, may be made from the same material as the outer walls 110,112. Alternatively, the sheath 154 may have a different structure, as may be apparent to one having ordinary skill in the art.

The score lines 50,150 may be cut into the pouches 1,100 via a focused laser beam that may score the film in both the machine direction and the transverse direction to form a patterned score line. Typically, a laser beam that may cut film in this manner is directed by a mirror that may be moved via an actuator. Of course, any method of directing the laser beam may be utilized as may be apparent to one having ordinary skill in the art. The laser beam may cut the first curved section 52a,152a of pouches 1,100, respectively, followed by the straight portions 52b, 152b, followed by the second curved portions 52c,152c. Further, the laser beam may cut a web of flexible film after the film has been extruded and/or laminated. Preferably, the multiple layers of the flexible film are coextruded and/or laminated, and the flexible film is slit and flattened into a sheet. The laser beam is then applied to a surface of the web to score the web in both the machine and transverse directions.

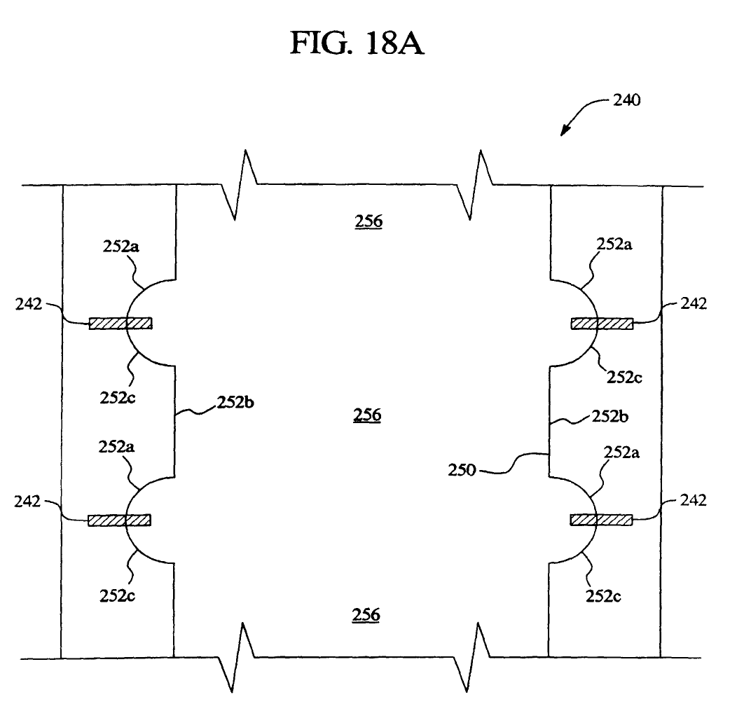

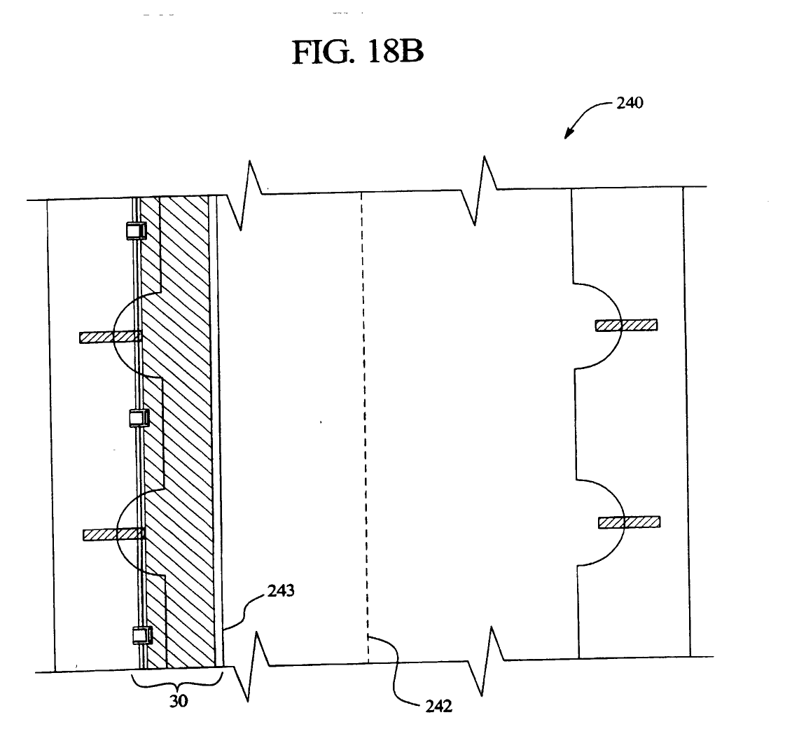

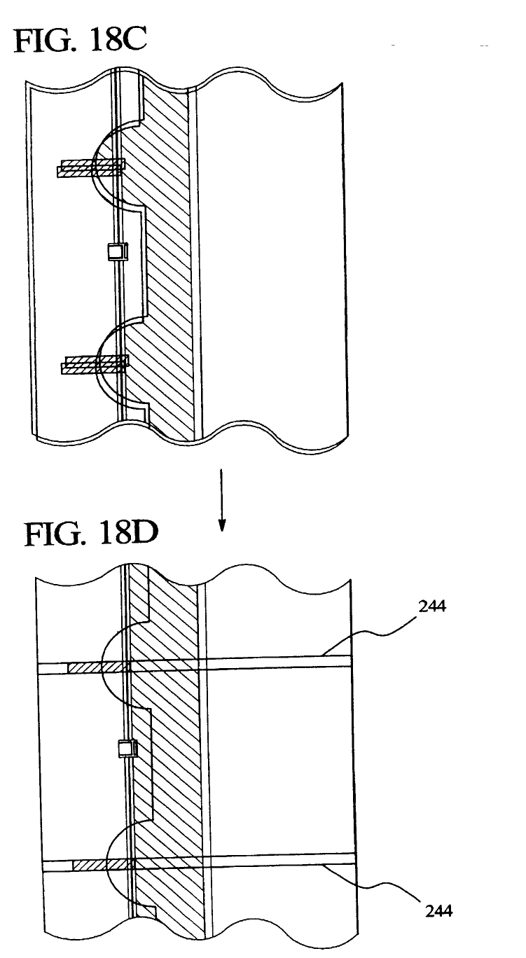

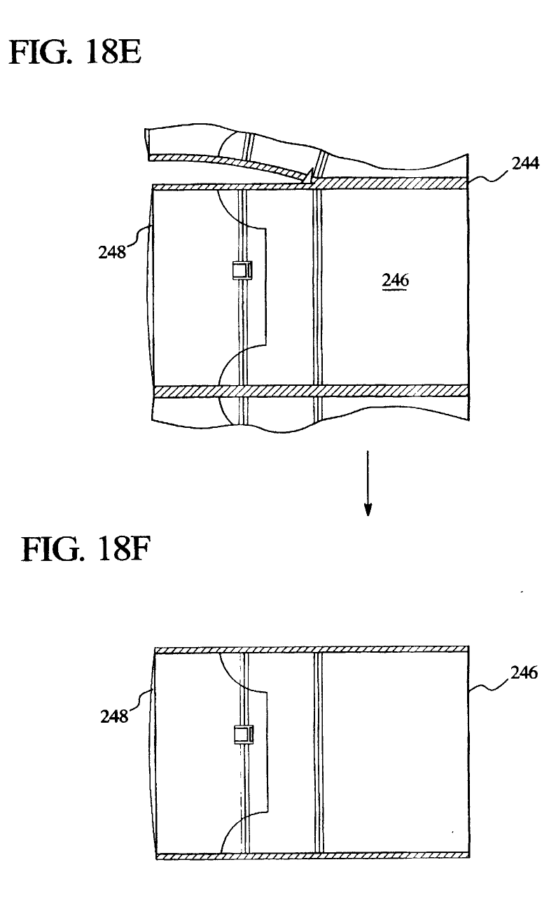

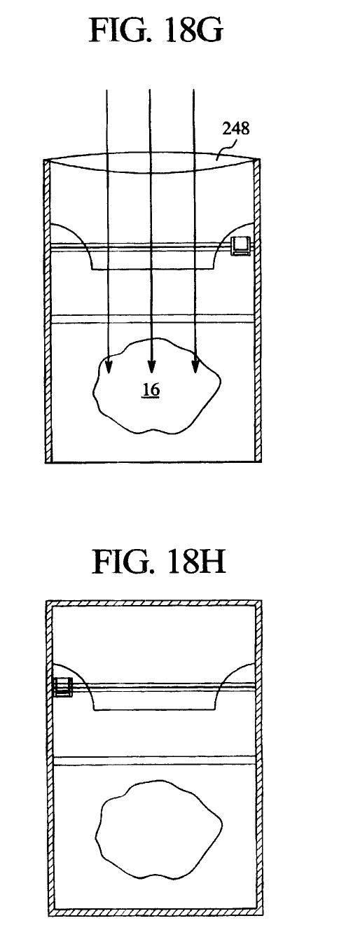

Each individual sheet portion 256, having score lines 250 cut therein by the laser beam, may be converted into the pouch 60, as shown in FIGS. 18A-18H. FIG. 18A shows a flexible film sheet 240 with laser scores thereon. The sheet 240 may have recurring patterns 242 thereon that aid a computer to precisely score the sheet 250 via the laser beam, or other scoring means. For example, the recurring patterns 242 indicate to a computer where and when to start cutting into the sheet 240 via the laser beam. The sheet 240 further has score lines 250 cut thereinto. The score lines 250 may be cut into both ends of the sheet 240 and may include recurring patterns of first curved portions 252a, straight portions 252b and second curved portions 252c. Of course, the score lines 250 may be cut into only one end of the sheet 240 as may be apparent to one having ordinary skill in the art. In addition, the laser beam that cuts the score lines 250 in the sheet 240 may move in two independent perpendicular directions to provide a patterned score line that is curved. The laser beam can cut the score line 250 into the sheet 240 without refocusing itself because the distance between the start of the first curved portion 252a or the second curved portion 252c and the straight portion 252b is a short distance, preferably about 0.75 inches.

The sheet 240 may then have the zipper system 30 added to a side of the sheet 240 on a first end of the sheet 240, as shown in FIG. 18B. The zipper system 30 may be sealed to the side of the sheet 240 by the application of heat to the zipper system 30 at heat seal 243. The sheet 240 may be folded along line 241 and the corresponding ends of the sheet 240 may be aligned, as shown in FIG. 18C. The two ends of the sheet 240 should be aligned precisely so that the score lines on each end of the sheet 240 are aligned. Heat is then applied to the zipper system 30 to seal the zipper system to the other end of the sheet 240 when the other end of the sheet 240 is aligned with the first end of the sheet 240. Moreover, heat is applied across the sheet 240 to seal the two ends of the sheet 240 together along heat seals 244, as shown in FIG. 18D. The heat seals 244 may be aligned with the patterns 242.

The sheet 240 may then be cut at the heat seals 244 by a blade, or any other means apparent to one having ordinary skill in the art, as shown in FIG. 18E to provide individual packages 246 having an open end 248 of the package 246. Each individual package 246 may then be filled with product 16 through the open end 248. The open end 248 may then be sealed to provide a package 246 folded on one side and sealed on the other three sides, with a recloseable zipper and a patterned score line thereby allowing the end of the package 246 to be removed when digital pull apart forces are applied to the package 246 along the score line.

### EXAMPLE 1

A package is constructed with a film having a first outer layer of 48 gauge oriented polyester, a second layer of low density polyethylene, a third layer of polyethylene, a fourth layer of a tie material, a fifth layer of a barrier material of ethylene vinyl alcohol, a sixth layer of a tie material, and seventh layer of a heat sealing polyethylene created by a single site catalyzed reaction. The above-identified seven layer structure may be coextruded and/or laminated together to form a flexible film that may be utilized to make the packages as described above. The score line provided in the film may be scored via a laser beam, creating a score line having a tensile value measured across the line of weakness of 6.5 lbs/in. The scored package is delivered as a wound roll to a filling line, such as a conventional horizontal form/vertical fill machine, such as a Bodolay, Bossar, Laudenberg, Klockner Bartelt. The empty package would then be formed, filled with a product, and hermetically sealed.

### EXAMPLE 2

A package may be formed of a film having substantially the same film structure as shown above, but with 60 gauge biaxially oriented nylon instead of 48 gauge oriented polyester.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A package for a product comprising:
a first side wall;
a second side wall wherein the first side wall and the second side wall are bonded together on edges to form a pouch having a space therein for storing a product;
a recloseable feature disposed on inside surfaces of the side walls wherein the side walls are sealed together on an end of the package; and
a score line in at least one side wall from a first edge to a second edge of the at least one side wall wherein the score line traces a path from above the recloseable feature at said first edge to below the recloseable feature between the edges when the pouch is oriented such that the recloseable feature is on a top side of the pouch.

2. The package of claim 1 wherein the recloseable feature is a recloseable zipper.

3. The package of claim 1 wherein the package is hermetically sealed on all sides.

4. The package of claim 1 further comprising a notch in the first edge of the at least one side wall at the score line.

5. The package of claim 1 wherein said recloseable feature extends from the first edge of said side walls to the second edge of said side walls.

6. The package of claim 1 wherein said recloseable feature has side edges wherein said side edges of said recloseable feature are integrally sealed to said side edges of said side walls.

7. The package of claim 1 wherein the first side wall and the second side wall are formed from a single piece of film and are connected together on a first side of the package via a fold.

8. The package of claim 7 wherein the recloseable feature is disposed near an end of the pouch and further wherein the fold is on an opposite end of the pouch from the recloseable feature.

9. The package of claim 7 wherein the recloseable feature is disposed near an end of the pouch and further wherein the fold is on the same end of the pouch as the recloseable feature.

10. A package for a product comprising:
a first side wall;
a second side wall wherein the first side wall and the second side wall are bonded together on edges to form a pouch having a space therein for storing a product;
a recloseable feature on an end of the package;
a sheath disposed over the recloseable feature wherein the sheath has a first end, a second end, and side edges, and further wherein a first end of the sheath is integrally attached to the side walls of the package; and
a score line in the sheath from a first edge to a second edge of the sheath wherein the score line traces a path from above the recloseable feature at the edges to below the recloseable feature between the edges when the pouch is oriented such that the recloseable feature is on a top side of the pouch.

11. The package of claim 10 wherein the recloseable feature is a recloseable zipper.

12. The package of claim 10 wherein the package is hermetically sealed on all sides.

13. The package of claim 10 further comprising a notch in the first edge of the package at the score line.

14. The package of claim 10 wherein said recloseable feature extends from the first edge of said side walls to the second edge of said side walls.

15. The package of claim 10 wherein said recloseable feature has side edges wherein said side edges of said recloseable feature are sealed to said side edges of said side walls.

16. The package of claim 10 wherein the first side wall and the second side wall are formed from a single piece of film and are connected together on a first side of the package via a fold.

17. The package of claim 16 wherein the recloseable feature is disposed near an end of the pouch and further wherein the fold is on an opposite end of the pouch from the recloseable feature.

18. The package of claim 16 wherein the recloseable feature is disposed near an end of the pouch and further wherein the fold is on the same end of the pouch as the recloseable feature.

19. A package for products comprising:
a pouch comprising side walls having a seal on all sides to form a space for retaining a product;
a recloseable feature disposed near one of the sealed sides of the pouch wherein the recloseable feature is sealed to inside surfaces of the pouch and further wherein the side walls extend over the recloseable feature; and
a score line in at least one side wall from a first edge to a second edge of the at least one side wall wherein the score line traces a path from above the recloseable feature at the side edges to below the recloseable feature between the side edges when the pouch is oriented such that the recloseable feature is on a top side of the pouch.

20. The package of claim 19 wherein the recloseable feature is a recloseable zipper.

21. The package of claim 19 wherein the package is hermetically sealed on all sides.

22. The package of claim 19 further comprising a notch in the first edge of a side wall at the score line.

23. The package of claim 19 wherein said recloseable feature extends from the first edge of said side walls to the second edge of said side walls.

24. The package of claim 19 wherein said recloseable feature has side edges wherein said side edges of said recloseable feature are integrally sealed to said side edges of said side walls.

25. The package of claim 19 wherein the side walls are formed from a single piece of film and are connected together on a first side of the package via a fold.

26. The package of claim 25 wherein the recloseable feature is disposed near an end of the pouch and further wherein the fold is on an opposite end of the pouch from the disposable feature.

27. The package of claim 25 wherein the recloseable feature is disposed near an end of the pouch and further wherein the fold is on the same end of the pouch as the recloseable feature.

28. A method of making a package comprising the steps of:
providing a first wall and a second wall;
scoring a score line in at least one side wall;
providing a recloseable feature attached at a first end of the side walls;
attaching the recloseable feature to inside surfaces of the side walls; and
sealing the first wall and the second wall together on edges of the walls to form a pouch having a space therein for a product,
wherein said score line is disposed above the recloseable feature at edges of the side walls and further wherein said score line traces a path to below the recloseable feature between the edges of the side walls.

29. A method of making a package comprising the steps of:
providing a sheet of a flexible film material;
providing a score line in the sheet of flexible film material;
sealing a first side of a recloseable feature to the flexible film material;
folding the sheet and sealing the sheet on side edges of the sheet to form a pouch having a space therein for a product wherein the pouch has an open end;
sealing a second side of the recloseable feature to the flexible film material;
filling the pouch with product; and
sealing the open end of the pouch,
wherein the score line is disposed in the sheet of flexible film material from a first to a second edge of the pouch wherein the score line traces a path from above the recloseable feature at the edges of the pouch to below the recloseable feature between the edges of the pouch when the pouch is oriented such that the recloseable feature is on a top side of the pouch.

30. A method of using a package comprising the steps of:
providing a package comprising a pouch having a product contained therein wherein said pouch has a recloseable feature on an end of the pouch and further wherein side walls of said pouch extend over the recloseable feature and further wherein said pouch has a score line disposed in the package from a first edge of the package to a second edge of the package wherein the score line traces a path from above the recloseable feature at the side edges of the package to below the recloseable feature between the side edges of the package; and
tearing said package along said score line to gain access to said pouch.
